(19) United States
(12) Patent Application Publication
(10) Pub. No.: US 2025/0206414 A1
(43) Pub. Date: Jun. 26, 2025

(54) AERODYNAMICALLY ENHANCED AIR LUBRICATION NOZZLE AND FLAP

(71) Applicant: AIRGLIDE AI, INC., FORT LAUDERDALE, FL (US)

(72) Inventors: David Bell, Naples, FL (US); Danilo Contreras, Davie, FL (US); JOHN DIXON, FORT LAUDERDALE, FL (US)

(73) Assignee: AIRGLIDE AI, INC., FORT LAUDERDALE, FL (US)

(21) Appl. No.: 19/075,734

(22) Filed: Mar. 10, 2025

Related U.S. Application Data
(63) Continuation-in-part of application No. 18/948,969, filed on Nov. 15, 2024.
(63) Continuation-in-part of application No. 18/219,375, filed on Jul. 7, 2023, now Pat. No. 12,263,914.
Application No. 18/219,375 is a continuation-in-part of application No. 18/119,324, filed on Mar. 9, 2023, now Pat. No. 12,097,932.
(60) Provisional application No. 63/563,086, filed on Mar. 8, 2024.
(60) Provisional application No. 63/563,250, filed on Mar. 8, 2024.
(60) Provisional application No. 63/599,360, filed on Nov. 15, 2023.
(60) Provisional application No. 63/454,549, filed on Mar. 24, 2023.
(60) Provisional application No. 63/439,306, filed on Jan. 17, 2023.
(60) Provisional application No. 63/427,144, filed on Nov. 22, 2022.

(51) Int. Cl. B63B 1/38

(52) U.S. Cl. CPC B63B 1/38; B63B 2001/387

(57) ABSTRACT

An air lubrication nozzle system. The air lubrication nozzle system includes an open cavity configured to receive a gaseous flow from a gaseous supply. The open cavity has an open bottom area flush with a plane of a bottom surface of a marine vessel in which said open cavity is installed. The system also includes a flap mount configured to affix to a front side wall of said open cavity. The flap mount includes an aerodynamically concave-curved upper surface, rear flap engagement area, and bottom surface substantially flush with the plane of a bottom surface of a marine vessel. The system also provides a flap engaged with the flap mount, whereby once engaged, the flap creates an openable flap.

### CROSS-REFERENCE TO RELATED APPLICATIONS

This application is a continuation-in-part of co-pending U.S. patent application Ser. No. 18/948,969, entitled “System and Method for Enhanced Marine Vessel Efficiency Using Integrated Hull Optimizations”, filed Nov. 15, 2024, and also claims priority as a continuation-in-part of co-pending U.S. patent application Ser. No. 18/219,375, entitled “A System and Method for Delivering Air to A Submerged Ship Surface”, filed Jul. 7, 2023.

U.S. patent application Ser. No. 18/948,969 is a continuation-in-part of U.S. patent application Ser. No. 18/219,375, which itself is a continuation-in-part of U.S. patent application Ser. No. 18/119,324, entitled “A System and Method for Reducing Drag On Hulls of Marine Crafts Thereby Increasing Fluid Dynamic Efficiencies”, filed Mar. 9, 2023, now U.S. Pat. No. 12,097,932, which claims the benefit of priority pursuant to 35 U.S.C. § 119 (e) to U.S. Provisional Patent Application Ser. No. 63/439,306, filed Jan. 17, 2023, and U.S. Provisional Patent Application Ser. No. 63/427,144, filed Nov. 22, 2022.

U.S. patent application Ser. No. 18/219,375 also claims priority pursuant to 35 U.S.C. § 119 (e) to U.S. Provisional Application Ser. No. 63/454,549, entitled “A System and Method for Delivering Air to A Submerged Ship Surface”, filed Mar. 24, 2023, and U.S. Provisional Application Ser. No. 63/599,360, entitled “A Drag-Reducing Bow Thruster Cover for Maritime Vessels”, filed Nov. 15, 2023.

This application further claims priority pursuant to 35 U.S.C. § 119 (e) to U.S. Provisional Patent Application Ser. No. 63/563,086, entitled “An Aerodynamically Enhanced Air Lubrication Nozzle and Flap System For V-Shaped Hull Surfaces”, filed Mar. 8, 2024, and U.S. Provisional Patent Application Ser. No. 63/563,250, entitled “Air Lubrication Nozzle With Enhanced Bi-Foil Flap System”, filed Mar. 8, 2024.

All of the above applications are hereby incorporated by reference in their entireties for all purposes.

### FIELD OF THE INVENTION

The present invention relates to the field fuel reduction for large marine vessels, and in particular, to air lubrication systems to reduce drag.

### BACKGROUND

Current means of distributing air to the underside of a ship's hull in air lubrication applications include chambered openings in the hull of a ship, as well as external attachments, such as belts, to provide air under the hull of a vessel. However, these systems all cause drag to the ship, especially when the system is not engaged, which reduces the overall efficiency of the operation. Further, even when the systems are on, these means of distributing air suffer from a number of energy loss conditions, where energy can transfer into resonant energy and heat from the resonation, furthering energy loss of the system.

In our previous applications and patents, for example: U.S. patent application Ser. No. 18/219,375, entitled “A System and Method for Delivering Air to A Submerged Ship Surface”, our solution discloses (in its simplest embodiment) a recessed cavity, known as a sea chest, with a closable flap that allows the cavity to be substantially sealed during forward motion to prevent drag when the system is off. However, there are additional calibrations that are necessary to continue optimizing the system, such as providing for the directional guidance of the gaseous flow of air to the underside surface of the hull. Providing such guidance reduces turbulence at the air water interface directly following the rear tip of the nozzle flap. In addition, by balancing the flow of the air against the hydrodynamic pressure, the flap disclosed herein closes when not in use by balancing the flow of the water against the weight of the flap. Therefore, a further need exists in the market for the precisely configured nozzle flap disclosed herein.

In addition, most air nozzles for air lubrication systems are directed to a flat bottom of a ship's hull, and not the inclining portions of hulls characterized by a V-shape. A V-shaped hull requires a carefully designed embodiment that distributes the air forcefully disproportionate over the linear opening of the nozzle to ensure the air does not rise to the top of the cavity and leave lower surfaces of the V-shaped hull without an air layer. The directioned nozzle, as disclosed herein, can also be configured to disburse air along angulated planes, such as the angulated walls of the bow of a vessel.

Thus, a need exists in the market for a carefully configured solution that maximizes efficiency and energy savings in the overall system, precisely delivering air to the underwater portions of a ship's hull, and reducing drag and turbulence wherever possible.

### SUMMARY OF THE INVENTION

The invention disclosed herein provides an air lubrication system nozzle assembly designed for marine vessels. The system includes a sea chest having an open cavity therein, wherein the sea chest comprises a gas flow inlet and an open lower boundary configured to receive a flow modulating nozzle flap. The flow modulating nozzle flap has a curved upper surface and is configured to modulate a direction and flow rate of a gaseous flow. The sea chest further includes at least one longitudinal engagement area, wherein the longitudinal engagement area is a rigidly fixed semi-circumferential bracket for mounting the flow modulating nozzle flap, affixed at a border of the open lower boundary. The flow modulating nozzle flap is coupled to the longitudinal engagement area, allowing it to respond to gaseous flow while remaining operable in a submerged environment.

The invention disclosed herein further provides a method for delivering air to an underside of a marine craft's submerged hull. The method includes configuring portions of a ship's hull for air delivery by providing at least one flush-installed linear nozzle, wherein each nozzle is an air lubrication nozzle assembly capable of being immersed continuously in a liquid. The air lubrication nozzle assembly includes a main body having an open cavity, wherein the open cavity comprises a gas flow inlet and an open lower boundary configured to receive a flow modulating nozzle flap. The open lower boundary is positioned flush with a transverse horizontal plane of the submerged hull of a ship. The flow modulating nozzle flap has a curved upper surface and is configured to modulate a direction and flow rate of a gaseous flow. The main body further comprises at least one longitudinal engagement area, whereby the flow modulating nozzle is coupled to the engagement area. The method ensures that the main body of each nozzle remains recessed up into the ship's hull, reducing drag when not in use.

The invention disclosed herein also provides an air lubrication nozzle system for use in reducing hydrodynamic drag on marine vessels. The air lubrication nozzle system includes an open cavity configured to receive a gaseous flow from a gaseous supply, wherein the open cavity has an open bottom area flush with the plane of a marine vessel's bottom surface. The system further includes a flap mount affixed to a front side wall of the open cavity, wherein the flap mount comprises an aerodynamically concave-curved upper surface, a rear flap engagement area, and a bottom surface substantially flush with the plane of a marine vessel's bottom surface. A flap is engaged with the flap mount, creating an openable flap that directs airflow along the hull surface. The flap further includes an aerodynamically concave-curved upper surface to facilitate the movement of air, ensuring controlled flow distribution from both the gaseous supply entering the open cavity and the air routed from the upper surface of the flap mount.

The invention disclosed herein further provides an air lubrication nozzle system configured for sloped surfaces of a marine vessel's hull. The system includes an open cavity configured to receive a gaseous flow from a gaseous supply, wherein the open cavity has an open bottom area flush with an angular surface of a marine vessel's hull. The system further includes a flap mount affixed to a front side wall of the open cavity, wherein the flap mount comprises an aerodynamically concave-curved upper surface, a rear flap engagement area, and a bottom surface substantially flush with a marine vessel's hull surface. A flap is engaged with the flap mount, creating an openable flap, wherein the flap is tapered, having a wider geometry at a lower portion that tapers into a narrower upper region. The tapered shape allows for uniform air distribution, regulating airflow by balancing pressure at the narrower region, thereby forcing the air to exit at a lower portion for enhanced dispersion. The flap mount further includes a complemental taper to match the changing geometry of the flap, ensuring efficient airflow along the hull surface.

It is an object of the present invention to provide a system capable of delivering a precisely controlled flow of gas and/or air to the underwater sides of a marine vessel capable of creating and supporting an air plastron.

It is yet another object of the present invention is to provide a system that includes a flap that reduces drag and turbulence typically associated with injecting air against a ship on surfaces under the water. The flap must push the air flow smooth against the hull and not just outward in any direction, in order to produce the right air boundary layer.

It is a further object to provide a system capable of easy installation and replacement.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates a bottom perspective view of the nozzle system installed flush into the hull of a watercraft, with flap opened.

FIG. 2 illustrates a bottom perspective view of the nozzle system installed flush into the hull of a watercraft, with flap closed.

FIG. 3 illustrates an isometric rear top partially transparent view of the nozzle flap system, with the top of the flap shown.

FIG. 4 illustrates an isometric front top partially transparent view of the nozzle flap system.

FIG. 5 illustrates a front top isometric view of the fixed flap mount of the nozzle flap system.

FIG. 6 illustrates a rear bottom isometric view of the fixed flap mount of the nozzle flap system.

FIG. 7 illustrates an isometric rear partially transparent view of the nozzle flap system, with flap shown in solid.

FIG. 8 illustrates side elevation view of the fixed flap mount of the nozzle flap system.

FIG. 9 illustrates a rear top isometric view of the flap of the nozzle flap system.

FIG. 10 illustrates a front top isometric view of the flap of the nozzle flap system.

FIG. 11 illustrates side elevation view of the flap of the nozzle flap system.

FIG. 12 illustrates side cross-sectional view of the flap and flap mount of the nozzle flap system with flap in a closed state.

FIG. 13 illustrates side cross-sectional view of the flap and flap mount of the nozzle flap system with flap in an opened state.

FIG. 14 illustrates side cross-sectional view of the flap and flap mount of the nozzle flap system with flap in a closed state.

FIG. 15 illustrates side cross-sectional view of the flap and flap mount of the nozzle flap system with flap in an opened state.

FIG. 16 illustrates a side cross-sectional conceptual view of a system without aerodynamic channel in an opened state creating turbulence.

FIG. 17 illustrates a side cross-sectional conceptual view of the system with aerodynamic channel in an opened facilitating a steady air plastron.

FIG. 18 illustrates a bottom front isometric view of an angulated nozzle flap for a sloped surface of the nozzle flap system.

FIG. 19 illustrates a bottom rear isometric view of an angulated nozzle flap for a sloped surface of the nozzle flap system.

FIG. 20 illustrates side cross-sectional view of an angulated nozzle flap for a sloped surface of the nozzle flap system.

FIG. 21 illustrates side cross-sectional view of cross sections from a ship, with a first showing an angulated surface having a nozzle cavity on either side, and a second cross section of a typical nozzle located at the bottom surface of a hull further back than the bow.

### DETAILED DESCRIPTION OF THE INVENTION

Air lubrication systems are an increasingly important technology in the maritime industry, aiming to improve fuel efficiency by reducing drag on a vessel's hull. These systems work by injecting air beneath the hull to create a thin layer of gas, known as an air plastron, which reduces friction between the ship and surrounding water. However, despite advancements in air lubrication technologies, significant inefficiencies remain, particularly with how air is introduced and controlled as it exits nozzles onto the hull surface. Traditional nozzle designs often result in turbulent airflow, excessive air loss, and uneven distribution, which ultimately diminish the effectiveness of the system.

In previous air lubrication systems, air is typically injected through chambered openings in the hull or via external air belts attached to the ship's bottom. While these methods can introduce air to the hull surface, they also have major drawbacks. First, they often create significant turbulence at the air-water interface, leading to energy losses that reduce overall efficiency. Second, when the system is off, these nozzles remain open, allowing water to flood the system and generate drag, which negates potential efficiency gains. Lastly, these nozzles do not offer directional control of the air as it exits, meaning a large portion of the injected air dissipates inefficiently rather than forming a stable air layer along the hull.

In our previously disclosed invention (see: U.S. patent application Ser. No. 18/219,375, entitled “A System and Method for Delivering Air to a Submerged Ship Surface), a solution was introduced that recesses an air injection cavity (or “sea chest”) within the hull and incorporates a closable flap to prevent drag when the system is inactive. This approach represented a significant improvement over traditional nozzle grates, but further refinement was needed to optimize airflow and reduce turbulence as air exits the system. Specifically, when air is simply injected into an open cubic cavity, it bounces around in unpredictable directions, creating randomized turbulence and preventing the formation of a smooth, energy-efficient air layer.

The present invention improves upon these prior systems by introducing a vectored air lubrication nozzle with an aerodynamically enhanced flap system. The flap includes a concave upper surface, which redirects and guides the airflow in a controlled rearward direction. This design applies principles of flow vectoring applications, where airflow is smoothly transitioned to prevent turbulent eddies. Instead of air being injected chaotically into the cavity and exiting at inefficient angles, the concave flap surface curves the airflow gently downward and rearward, ensuring that air adheres to the hull rather than dispersing unpredictably.

A key innovation of this system is that it balances aerodynamic and hydrodynamic pressures to improve efficiency. The vectored flap ensures that air exits in alignment with the natural water flow under the hull, preventing disruptive interactions between the injected air and the surrounding water. This results in a smoother air-water interface, which reduces resistance and improves the longevity of the air plastron. Additionally, by minimizing turbulence at the nozzle exit, the system reduces unnecessary energy expenditure, further enhancing fuel efficiency.

Another major advancement in this disclosure is the application of the vectored flap system to sloped and V-shaped hull surfaces. In traditional air lubrication systems, nozzles are typically designed for flat-bottom hulls, where air is more likely to spread evenly. However, for vessels with V-shaped bows or inclined hull sections, air injection becomes significantly more challenging because air naturally rises within the cavity, leaving lower portions of the V-shape without coverage. This creates uneven lubrication, reducing overall system effectiveness.

To solve this issue, this invention introduces a tapered flap geometry that ensures even air distribution along sloped surfaces. The flap is wider at the lower portion and narrows at the upper region, which forces air to distribute downward instead of accumulating at the top of the cavity. This configuration ensures that all regions of the hull receive a continuous layer of air, which is particularly critical for ships with non-flat hull geometries.

In addition to improving airflow vectoring, the disclosed system also includes passive closure enhancements. The flap is designed to automatically close when air is not being injected, using a combination of buoyancy forces, flap weight, and hydrodynamic pressure. Unlike traditional systems where open nozzles create unnecessary drag when not in use, this self-sealing design eliminates parasitic resistance, further optimizing fuel savings.

The results of these improvements are substantial. By optimizing air distribution, reducing turbulence, and ensuring a stable air layer, this system significantly increases energy efficiency compared to conventional air lubrication methods. Ships equipped with this system experience lower fuel consumption, reduced carbon emissions, and enhanced overall performance. Additionally, because the nozzle flap is modular and replaceable, the system allows for easy maintenance and upgrades, making it a highly adaptable solution for various ship designs.

In our previous patent applications, including U.S. patent application Ser. No. 18/219,375, entitled “A System and Method for Delivering Air to a Submerged Ship Surface”, we disclosed a fundamental air lubrication system featuring a recessed cavity, or sea chest, with a closable flap. This design allowed the cavity to remain sealed during forward motion when the system was inactive, effectively eliminating unnecessary drag. While this was a significant improvement over conventional systems, further refinements were needed to enhance air distribution and minimize turbulence at the air-water interface. Specifically, the system required precise directional control of the exiting air to ensure an optimal laminar flow along the hull. Without such guidance, air could disperse chaotically, increasing turbulence and energy losses. Additionally, the flap needed to balance hydrodynamic and aerodynamic forces to ensure reliable closure when the system is off, preventing water ingress and unwanted drag.

The present invention addresses these challenges by introducing a precisely engineered nozzle flap system that enhances both energy efficiency and aerodynamic performance. At its core, the system features a flap with a concave aerodynamic curvature that guides the gaseous flow in a controlled rearward direction, ensuring smooth air distribution across the hull. This prevents turbulent interactions at the air-water interface, resulting in a more stable and effective air plastron that reduces frictional drag.

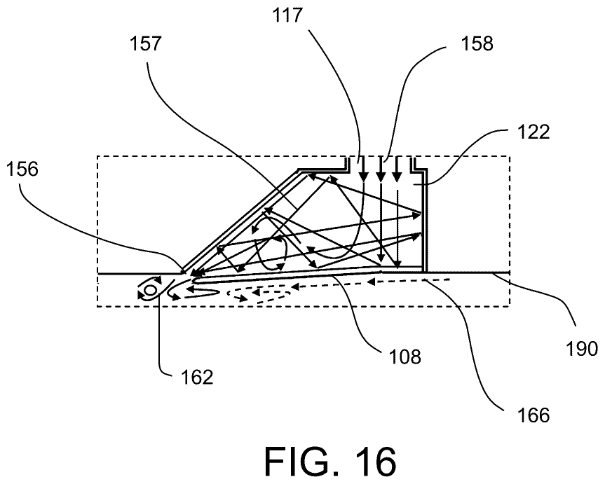

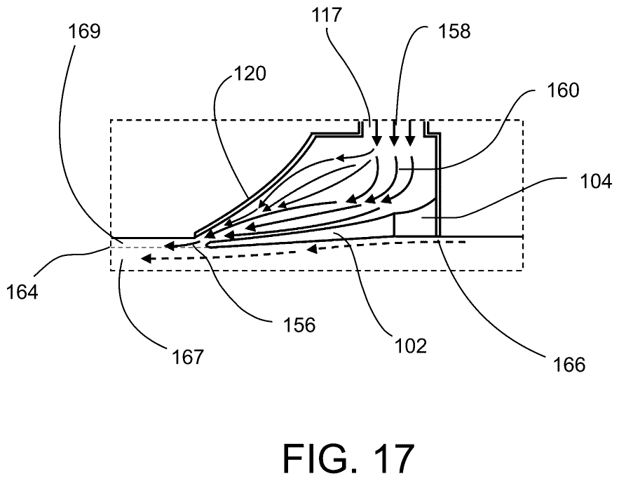

A key aspect of this improvement is the creation of a uniform trailing edge, which provides a gentle transition between the water beneath the hull and the injected air. This transition minimizes turbulence, preventing the formation of eddies and vortices that could otherwise disrupt the air lubrication layer. The effectiveness of this feature can be observed in FIGS. 16 and 17, where FIG. 15 illustrates the turbulence present in traditional systems, while FIG. 17 demonstrates the substantial reduction of turbulence achieved with the disclosed invention.

Another advantage of the present system is its modular two-part flap design, which allows for easy maintenance and upgrades. The fixed portion of the flap is mounted to the forward interior surface of the cavity, and in some embodiments, it may be secured to a bracket or other structural support. The movable portion of the flap is designed for dynamic airflow modulation and can be constructed from buoyant materials, allowing it to naturally rise and close when not in use. The combination of buoyancy and hydrodynamic forces ensures that the nozzle remains sealed during forward motion, reducing unnecessary drag. Additionally, during operation, the flap dynamically balances the aerodynamic and hydrodynamic forces, adjusting to the flow conditions to maintain optimal performance.

The flap's unique tapered geometry further enhances air distribution by ensuring that air flows to areas that would otherwise receive insufficient coverage. In conventional designs, air naturally rises within the cavity, leading to uneven lubrication-particularly on angled hull surfaces. The tapered flap shape counteracts this tendency by forcing air downward through a narrower upper opening, redistributing airflow to ensure comprehensive coverage across the entire hull section. This innovation makes the system particularly well-suited for implementation on V-shaped hulls, such as those found near the bow of a vessel, where conventional systems struggle to maintain consistent air coverage.

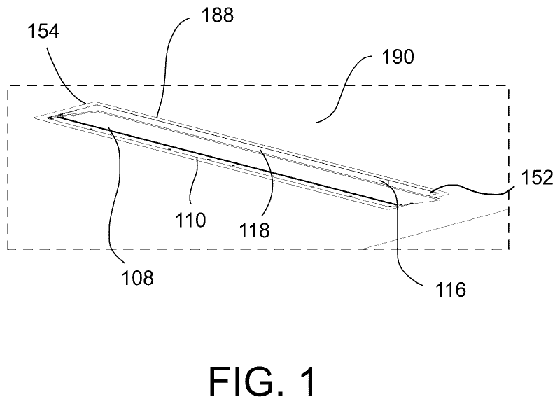

The aerodynamically enhanced air lubrication nozzle and flap system disclosed herein offers a highly controlled method for delivering air to the submerged portions of a marine vessel. This system not only creates and sustains an air plastron, but also minimizes turbulence and drag, ensuring efficient boundary layer formation. Unlike conventional nozzles that merely inject air outward, this system directs and shapes the air layer to align with the hull, resulting in greater energy savings and improved vessel performance. The system's core principles and embodiments are detailed in FIGS. 1-21.

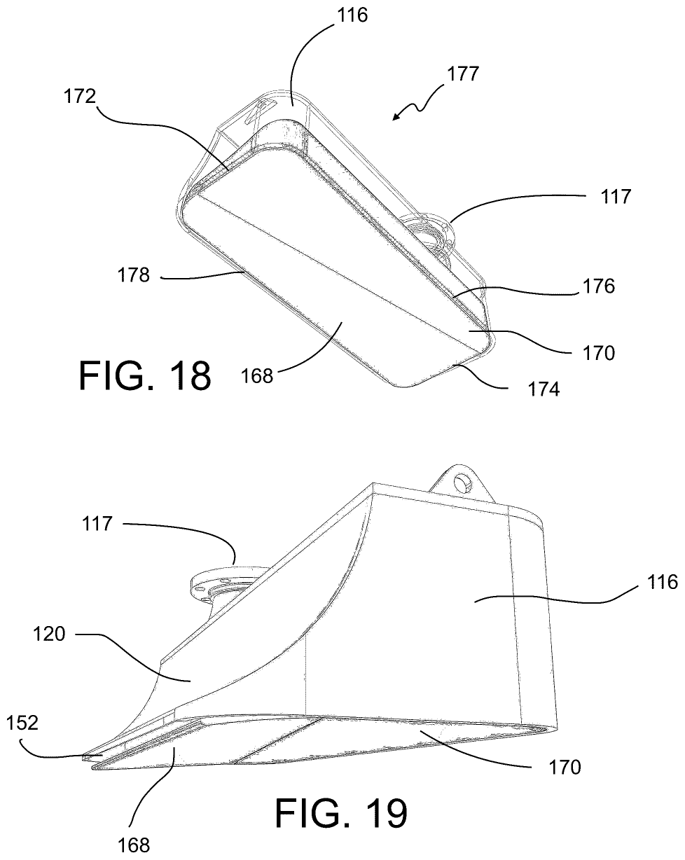

Additionally, this invention extends its application to V-shaped hull surfaces, addressing a longstanding challenge in air lubrication technology. By incorporating directional airflow guidance and optimized flap geometries, the system ensures effective lubrication across sloped surfaces, preventing air voids or inefficient dispersion. This capability is critical for modern ship designs, where the bow and other angled sections require precisely engineered air injection mechanisms. The configuration and function of the embodiment is illustrated in FIGS. 18-21.

FIG. 1 illustrates a bottom perspective view of the nozzle system installed flush into the hull 190 of a watercraft, with the flap 102 in an opened state. The nozzle opening 152, which is the gap between the rear of the sea chest 116 and the flap 102, is visible, allowing for controlled air release. The open lower boundary 154 of the sea chest 116 defines the bottom edge of the cavity 118, which houses the flap 102. The forward engagement area 110 of the sea chest 116 secures the flap mount 104, ensuring proper operation. The bottom surface of the flap 108 is also shown, demonstrating its alignment with the hull 190 when in a closed position.

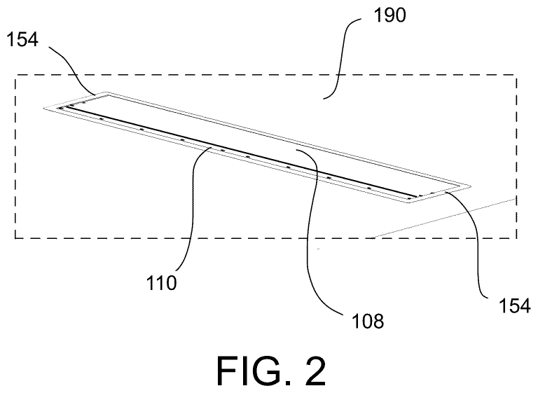

FIG. 2 illustrates a bottom perspective view of the nozzle system installed flush into the hull 190 of a watercraft, with the flap 102 in a closed state. The bottom surface of the flap 108 is flush with the surrounding hull 190, minimizing drag. The forward engagement area 110 secures the flap mount 104, maintaining the integrity of the system when not in use. The open lower boundary 154 is sealed by the flap 102, preventing water ingress into the sea chest 116 and reducing turbulence when air is not being expelled.

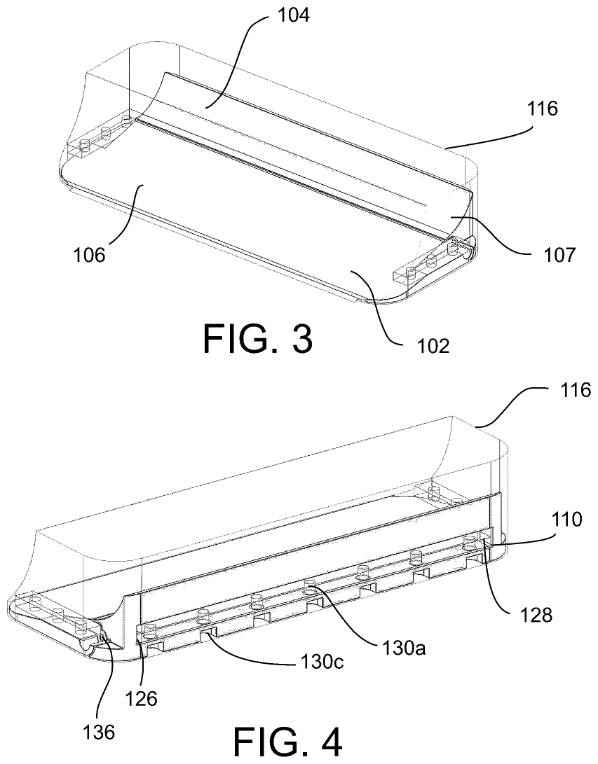

FIG. 3 illustrates an isometric rear top partially transparent view of the nozzle flap system, with the top of the flap 102 shown. The flap mount 104 is securely positioned within the sea chest 116, forming a stable mounting area for the hinged flap 102. The curvature 107 of the flap 102 is visible, demonstrating its aerodynamic profile designed to direct air flow. The sea chest 116 encloses the cavity 118, which serves as the air distribution area before the air exits through the nozzle opening 152.

FIG. 4 illustrates an isometric front top partially transparent view of the nozzle flap system. The sea chest 116 is shown with its longitudinal engagement area 110, which secures the semi-circumferential bracket 128 that holds the flap mount 104 in place. Securement screw channels 130a and bracket recess 126 are also depicted, demonstrating the assembly method for affixing the flap mount 104 to the sea chest 116.

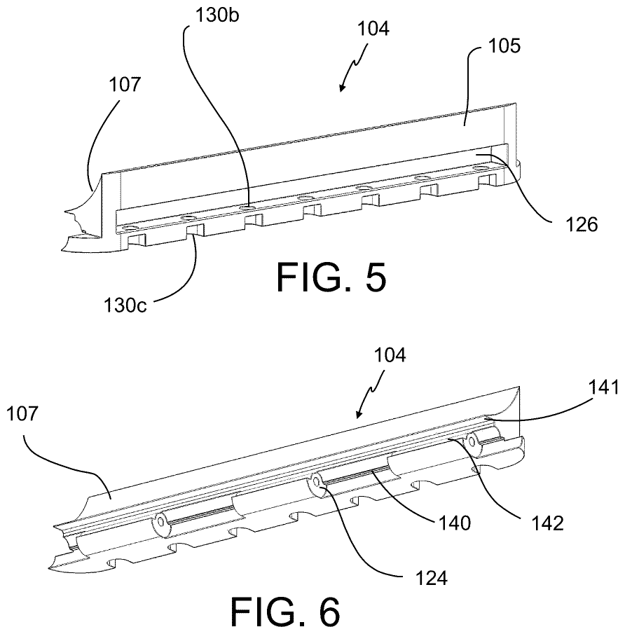

FIG. 5 illustrates a front top isometric view of the fixed flap mount 104 of the nozzle flap system. The curved upper surface 107 of the flap mount 104 is designed to streamline airflow. Recess channels 130c and screw apertures 130b are present to facilitate secure attachment. The bracket recess 126 is also shown, allowing integration with the sea chest 116 to ensure proper operation.

FIG. 6 illustrates a rear bottom isometric view of the fixed flap mount 104 of the nozzle flap system. The interdigital hinge area 124, which consists of male and female engagement sections, is depicted, demonstrating the mechanical coupling between the flap 102 and the flap mount 104. Stopper shelf 142 and upper stopper surface 140 are also visible, preventing excessive downward movement of the flap 102. The curved upper surface 107 of the flap mount 104 is shown, which contributes to controlled air distribution.

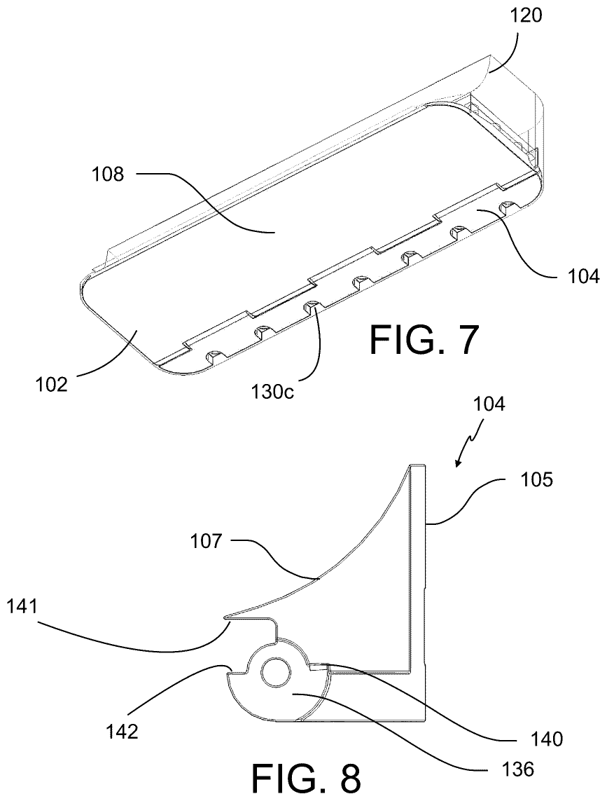

FIG. 7 illustrates an isometric rear partially transparent view of the nozzle flap system, with the flap 102 shown in solid. The flap mount 104 is secured within the sea chest 116, forming a stable base for the flap 102. The connection recesses 130c for the flap mount 104 are visible, ensuring proper engagement. The curved rear surface 120 of the sea chest 116 is shown, assisting in airflow guidance.

FIG. 8 illustrates a side elevation view of the fixed flap mount 104 of the nozzle flap system. The curved upper surface 107 of the flap mount 104 is designed to direct airflow efficiently. The upper limit 140 for the stopper on the flap mount 104 and the lower shelf 142 of the stop limit means are shown, controlling the movement range of the flap 102. The flush surface 105 abuts the sea chest 116 to maintain structural stability. The hinge area 136 is depicted, enabling rotational movement of the flap 102.

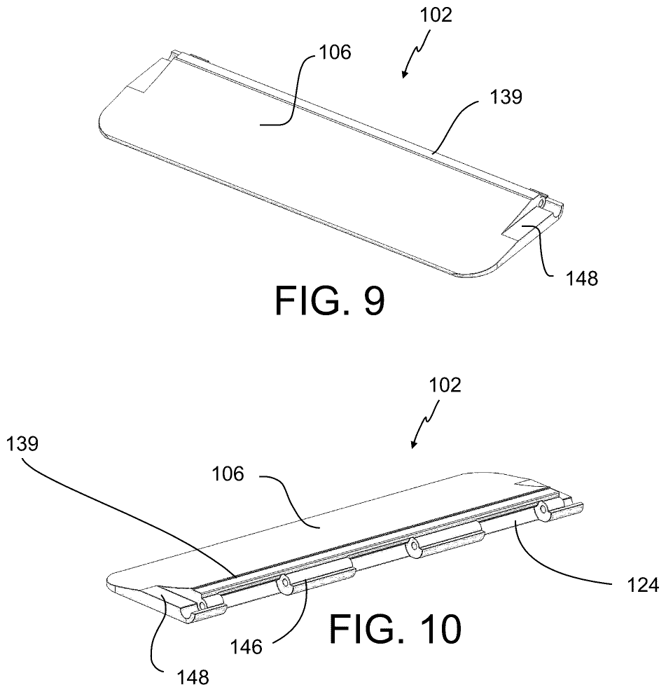

FIG. 9 illustrates a rear top isometric view of the flap 102 of the nozzle flap system. The curved upper surface 106 of the flap 102 is designed for efficient air guidance. The stop limit 144 on the flap 102 ensures controlled movement. Side stop limits 148, which interact with a separate bracket, are shown to prevent lateral displacement.

FIG. 10 illustrates a front top isometric view of the flap 102 of the nozzle flap system. The hinge area 136, which secures the flap 102 to the flap mount 104, is shown. The stop limit 144 on the flap 102 and the lower stop limit 146, which interacts with the upper stop limit on the flap mount 104, are depicted to control the range of rotational movement of the flap 102.

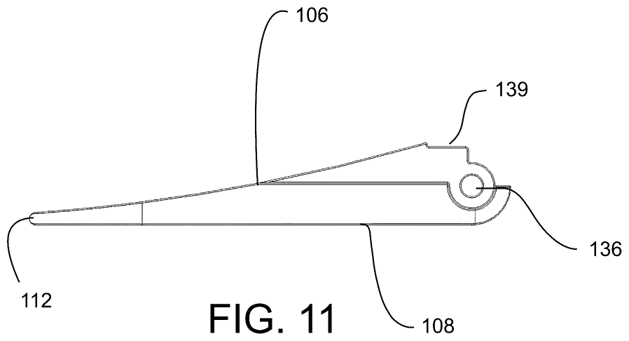

FIG. 11 illustrates a side elevation view of the flap 102 of the nozzle flap system. The concave surface 106 of the flap 102 is shown, facilitating aerodynamic air distribution. The stop limit 144 and hinge area 136 are illustrated. The rear flap tip 112 is also visible, defining the lower boundary which influences the air outlet area.

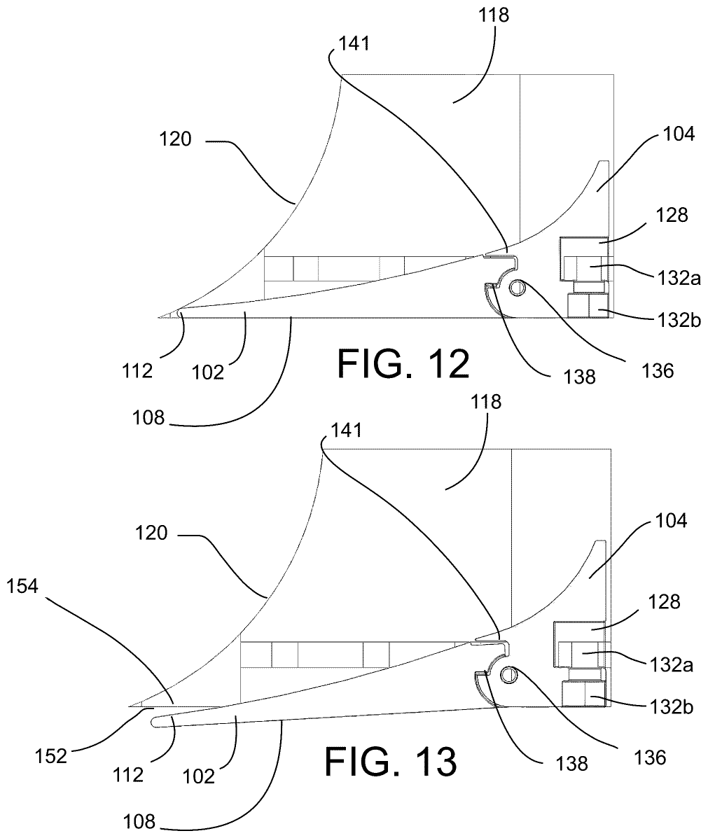

FIG. 12 illustrates a side cross-sectional view of the flap 102 and flap mount 104 of the nozzle flap system with the flap 102 in a closed state. The open cavity 118, formed within the sea chest 116, is enclosed at the lower boundary by the flap 102, which remains flush against the lower surface of the hull 190, minimizing hydrodynamic resistance. The curved rear surface 120 of the sea chest 116 is shown, directing airflow when the system is engaged. The stop limit area 138 is depicted, restricting excessive downward movement of the flap 102 when opened or at rest and no hydrodynamic forces are pressing on the lower surface 108 of the flap 102 (which is particularly appreciated in FIG. 13). The rear tip 112 of the flap 102 is shown in its closed position. The flap mount 104, secured to the sea chest 116, provides structural support for the flap 102. The semi-circumferential bracket 128, along with the nut 132a and screw 132b, is illustrated, securing the bracket 128 to the flap mount 104. The hinge area 136 is depicted, enabling rotational movement of the flap 102.

FIG. 13 illustrates a side cross-sectional view of the flap 102 and flap mount 104 of the nozzle flap system with the flap 102 in an opened state. In this configuration, the nozzle opening 152 is created between the rear tip 112 of the flap 102 and the curved rear surface 120 of the sea chest 116, permitting the controlled release of pressurized air. The open lower boundary 154 is visible, marking the lowest portion of the sea chest 116. The curved upper surface 107 of the flap mount 104 helps guide the airflow as it exits the nozzle opening 152. The stop limit area 138 is engaged, preventing excessive downward displacement of the flap 102 beyond a predefined limit. The semi-circumferential bracket 128, along with the nut 132a and screw 132b, is illustrated, securing the bracket 128 to the flap mount 104. The hinge area 136 is depicted, enabling rotational movement of the flap 102.

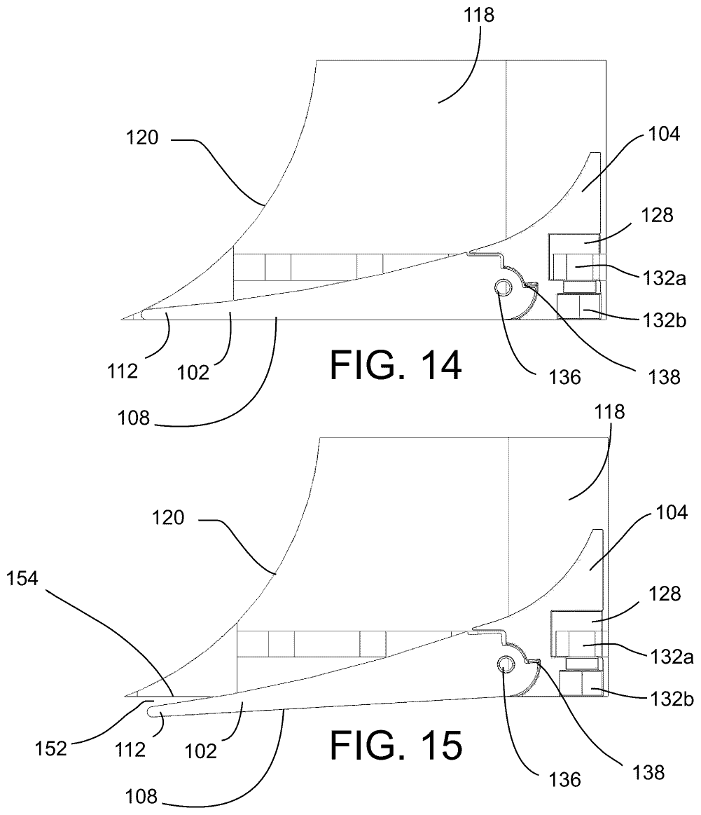

FIGS. 14 and 15 illustrate side cross-sectional view of the flap and flap mount of the nozzle flap system with flap in a closed state and an open state, respectively, similar to the views in FIGS. 12 and 13. The main difference between FIGS. 14 and 15 and FIGS. 12 and 13 is the cross-sectional position of the figures. The cross-sections depict the different parts of the stop limit around the hinge 138 point, as may be appreciated from FIGS. 6 and 10, emphasizing the stop limit surfaces 140, 142, 144, 146.

FIG. 16 illustrates a side cross-sectional conceptual view of a system without an aerodynamic channel in an opened state, creating turbulence. The air inflow 158 enters the cubic cavity 122 and disperses chaotically within the cavity due to the absence of a structured guiding surface. This lack of directional control results in chaotic airflow 157, causing the air outflow 156 to exit in an irregular manner. The bottom surface of the hull 190 interacts with hydrodynamic flow 166, leading to increased turbulence 162 at the air/water interface. The flat bottom surface 108 of the flap 102 fails to regulate the dispersion of air, reducing the efficiency of the air lubrication effect.

FIG. 17 illustrates a side cross-sectional conceptual view of the system with an aerodynamic channel in an opened state, facilitating a steady air plastron 169. The curved upper surface 106 of the flap 102 and the curved upper surface 107 of the flap mount 104 guide the air inflow 158 into a controlled path. As the air exits through the nozzle opening 152, the guided air 160 forms a structured air outflow 156, reducing turbulence and promoting stable adhesion of the air layer to the hull 190. The hydro flow forces 166 interact smoothly with the structured airflow, enhancing the formation of an effective air/water interface 164. The curved rear interior surface 120 of the sea chest 116 further aids in directing the airflow for optimal performance.

FIG. 18 illustrates a bottom front isometric view of an angulated nozzle flap for a sloped surface of the nozzle flap system. This embodiment is specifically designed for integration into non-horizontal sections of a ship's hull. The tapered embodiment 177 includes a tapered flap 168 secured within a tapered flap mount 170, both of which are adapted to follow the angular contours of a sloped hull. The sea chest 116 is modified to accommodate the change in geometry, ensuring efficient air distribution. The air inlet 117 is positioned to introduce pressurized air into the system, which is then guided through the cavity 118 before controlled release through the nozzle opening 152.

FIG. 19 illustrates a bottom rear isometric view of an angulated nozzle flap for a sloped surface of the nozzle flap system. The tapered flap 168 and tapered flap mount 170 are depicted, showing how the system is adapted for sloped hull sections. The air inlet 117 directs pressurized air into the cavity 118, which is then guided along the interior surfaces of the nozzle system. The air outflow 156 is channeled through the nozzle opening 152, ensuring uniform distribution of air along the sloped hull surface. This configuration enables optimized air lubrication even on inclined sections of a marine vessel's hull, where conventional horizontal nozzles may be ineffective.

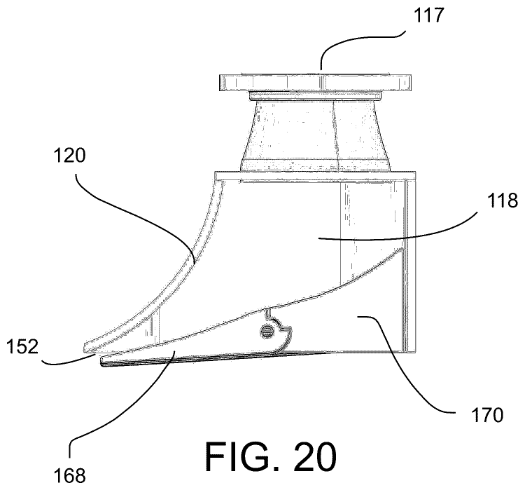

FIG. 20 illustrates a side cross-sectional view of an angulated nozzle flap for a sloped surface of the nozzle flap system. The sea chest 116 defines the outer boundary of the open cavity 118, directing airflow toward the nozzle opening 152. The air inlet 117 introduces pressurized air into the cavity 118, which is regulated by the movement of the tapered flap 168. The tapered flap mount 170 secures the flap 168 and ensures proper alignment along the ship's side. The interior rear curved surface 120 of the sea chest 116 aids in smoothly guiding air toward the nozzle opening 152. The tapered configuration of the flap 168 allows uniform air distribution by adjusting the airflow path, forcing air to be directed toward the lower open area for controlled expulsion.

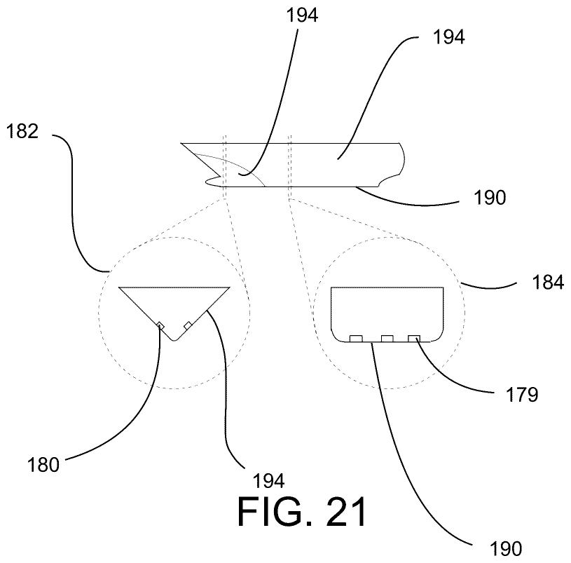

FIG. 21 illustrates a side cross-sectional view of different nozzle system configurations on a ship's hull 190. The first cross-section demonstrates the implementation of an angled nozzle system along a sloped hull, incorporating a side-sea chest 180 with a nozzle cavity positioned on either side of the v-shaped hull 182. This configuration adapts to the hull's angular geometry to optimize air lubrication. The second cross-section represents a conventional bottom-sea chest 179 with a nozzle flap system installed along the lower hull 190 toward the aft section of the vessel 192. The side of the v-shape hull 194 highlights how air lubrication can be tailored to different hull geometries to maximize drag reduction efficiency.

In an exemplary embodiment, an air lubrication system nozzle assembly 102 is disclosed. The air lubrication system nozzle assembly 102 includes a sea chest 116 having an open cavity 118 therein, wherein the sea chest 116 includes a gas flow inlet 117 and an open lower boundary 154 configured to receive a flow modulating nozzle flap 102. The flow modulating nozzle flap 102 features a curved upper surface 106 and is configured to modulate a direction and flow rate of a gaseous flow. The sea chest 116 further comprises at least one longitudinal engagement area 110, wherein the at least one longitudinal engagement area 110 includes a rigidly fixed semi-circumferential bracket 128 for mounting the flow modulating nozzle flap 102. The rigidly fixed semi-circumferential bracket 128 is affixed at a border of the open lower boundary 154 to provide a stable coupling location for the flow modulating nozzle flap 102. The air lubrication system nozzle assembly 102 is operable in a submerged environment and facilitates controlled air distribution beneath the hull 190 of a marine vessel.

In some embodiments, the flow modulating nozzle flap 102 is coupled to the sea chest 116 at the at least one longitudinal engagement area 110. The at least one longitudinal engagement area 110 is positioned at a forward area to direct the flow of water under the flow modulating nozzle flap 102 and provide a surface for hydrodynamic forces to press against, thereby closing the flow modulating nozzle flap 102 when no air is being dispensed from the nozzle opening 152. This configuration ensures that when the air lubrication system nozzle assembly 102 is not actively delivering air, the flap 102 remains in a closed position to minimize drag and maintain hydrodynamic efficiency.

In another exemplary embodiment, a method for providing air to an underside of a marine craft's submerged hull is disclosed. The method includes configuring portions of a ship's hull 190 for air delivery to the ship's hull's lower surface by providing at least one flush-installed linear nozzle, wherein each of the at least one flush-installed linear nozzle is an air lubrication nozzle assembly 102. The method further includes providing the air lubrication nozzle assembly 102, wherein the air lubrication nozzle assembly 102 is capable of being immersed continuously in a liquid. The air lubrication system nozzle assembly 102 includes a main body having an open cavity 118 therein, wherein the main body includes a gas flow inlet 117 and an open lower boundary 154 configured to receive a flow modulating nozzle flap 102, wherein the open lower boundary 154 is flush with a transverse horizontal plane of the submerged hull 190 of a ship surrounding the open lower boundary 154. The method also includes providing a flow modulating nozzle flap 102, wherein the flap has a curved upper surface 106 and is configured to modulate a direction and flow rate of a gaseous flow. The main body of the nozzle assembly 102 further includes at least one longitudinal engagement area 110, whereby the flow modulating nozzle flap 102 is coupled to the at least one longitudinal engagement area 110. The air lubrication system nozzle assembly 102 is operable in a submerged environment, wherein the main body of each nozzle in the at least one flush-installed linear nozzle is recessed up into the ship's hull 190 to optimize fluid dynamics and minimize drag.

In some embodiments, the air lubrication system nozzle assembly 102 includes a semi-circumferential bracket 128 for mounting the flow modulating nozzle flap 102. This semi-circumferential bracket 128 ensures the stable engagement of the flap 102, allowing it to operate efficiently in submerged conditions.

In some embodiments, the air lubrication nozzle assembly 102 is capable of performing the steps of lowering the flow modulating nozzle flap 102 by using a flow of gas received from the gas flow inlet 117. The flow of gas disburses uniformly in the open cavity 118 of the main body, thereby pressing on the flow modulating nozzle flap 102 to allow air to disburse to the underside of the marine craft's hull 190 when air lubrication is required. The method also includes raising the flow modulating nozzle flap 102 by terminating the flow of gas received from the gas flow inlet 117, wherein a passive lifting system is incorporated into the flow modulating nozzle flap 102 to allow for self-closure when air is no longer required under the marine craft's hull 190. This system ensures efficient air lubrication while maintaining hydrodynamic efficiency when not in use.

In a further exemplary embodiment, an air lubrication nozzle system is disclosed. The air lubrication nozzle system includes an open cavity 118 configured to receive a gaseous flow from a gaseous supply, wherein the open cavity 118 has an open bottom area flush with a plane of a bottom surface of a marine vessel 190 in which the open cavity 118 is installed. The system further includes a flap mount 104 configured to affix to a front side wall of the open cavity 118, wherein the flap mount 104 includes an aerodynamically concave-curved upper surface 107, a rear flap engagement area, and a bottom surface substantially flush with the plane of a bottom surface of a marine vessel 190. The system also includes a flap 102 engaged with the flap mount 104, whereby once engaged, the flap 102 creates an openable flap. The flap 102 further includes an aerodynamically concave-curved upper surface 106 to guide the gaseous flow from a gaseous supply entering the open cavity 118 and the gaseous supply routed from the upper surface 107 of the flap mount 104.

In some embodiments, the air lubrication nozzle system includes a rear interior surface wall 120 of the open cavity 118 that is convex-curved to assist with guiding a gaseous supply from an inlet 117 to an opening 152 between the flap 102 and the rear interior surface wall 120. This configuration ensures that the air is effectively directed and controlled for optimal lubrication under the hull.

In some embodiments, the flap 102 is capable of creating a substantially sealed lower surface when a vessel is moving in a forward direction and no gaseous flow is traversing the open cavity 118. This ensures that the system remains hydrodynamically efficient when not in active use, preventing unnecessary turbulence or drag.

In some embodiments, the air lubrication nozzle system further comprises a stop limit means incorporated into a hinge mechanism 136 between the flap 102 and the flap mount 104, whereby the stop limit means allows the vessel to reverse without the flap 102 descending below a threshold of approximately 10 mm below the hull 190 of the ship.

In some embodiments, the stop limit means comprises a hinge mechanism 136 pivotally coupling the flap 102 and the flap mount 104 around a hinge point. The hinge point allows the flap 102 to rotate radially up and down between a predetermined distance contained between an upper shelf 140 and a lower shelf 142 on a flap mount portion of the hinge mechanism 136, thereby creating a female hinge cavity. The flap 102 has a male engagement insert having complemental geometry to the female hinge cavity, whereby the male engagement insert of the flap 102 will stop rotating upon reaching the upper or lower shelf 140, 142 of the flap mount 104. A bumper may also be disposed on the lower shelf 142 of the flap mount 104 to accept compressive force acting upon the bumper by the male engagement insert of the flap 102 when the flap 102 is receiving downwardly pulling forces from the submerged environment surrounding the flap 102. This structure prevents excessive movement of the flap 102, ensuring its stability and proper operation under various marine conditions.

In another exemplary embodiment, an air lubrication nozzle system is disclosed. The air lubrication nozzle system includes an open cavity 118 configured to receive a gaseous flow from a gaseous supply, wherein the open cavity 118 has an open bottom area flush with an angular surface of a marine vessel's hull 190 in which the open cavity 118 is installed. The system further includes a flap mount 170 configured to affix to a front side wall of the open cavity 118, wherein the flap mount 170 includes an aerodynamically concave-curved upper surface 107, a rear flap engagement area, and a bottom surface substantially flush with the plane of a bottom surface of a marine vessel 190. The system also includes a flap 168 engaged with the flap mount 170, whereby once engaged, the flap 168 creates an openable flap. The flap 168 is tapered, having a wider geometry at a lower portion tapering into a narrow portion at an upper region, whereby the tapering allows a uniform air distribution by balancing the flow at a narrow opening where the air is more likely to flow, forcing the air to distribute lower to an open area where it can exit more easily. The flap mount 170 includes a complemental taper to that of the flap 168 to accommodate for a change in geometry of the flap 168.

In some embodiments, the flap 168 includes an aerodynamically concave-curved upper surface 106 to guide the gaseous flow from both the gaseous supply and from a gaseous supply entering the open cavity 118 and the gaseous supply routed from the upper surface 107 of the flap mount 170.

In some embodiments, a rear interior surface wall 120 of the open cavity 118 is convex-curved to assist with guiding a gaseous supply from an inlet 117 to an opening 152 between the flap 168 and the rear interior surface wall 120.

In some embodiments, the flap 168 includes an aerodynamically concave-curved upper surface 106 to guide the gaseous flow from both the gaseous supply and from a gaseous supply entering the open cavity 118 and the gaseous supply routed from the upper surface 107 of the flap mount 170.

In some embodiments, the openable flap 168 is capable of creating a substantially sealed surface when a vessel is moving in a forward direction and no gaseous flow is traversing the open cavity 118, thereby reducing hydrodynamic drag and improving system efficiency.

In some embodiments, the air lubrication nozzle system further comprises a stop limit means incorporated into a hinge mechanism 136 between the flap 168 and the flap mount 170, whereby the stop limit means allows the vessel to reverse without the flap 168 descending below an acceptable threshold.

In some embodiments, the stop limit means comprises a hinge mechanism 136 pivotally coupling the flap 168 and the flap mount 170 around a hinge point. The hinge point allows the flap 168 to rotate radially up and down between a predetermined distance contained between an upper shelf 140 and a lower shelf 142 on a flap mount portion of the hinge mechanism 136, thereby creating a female hinge cavity. The flap 168 has a male engagement insert having complemental geometry to the female hinge cavity, whereby the male engagement insert of the flap 168 will stop rotating upon reaching the upper or lower shelf 140, 142 of the flap mount 170. A bumper may also be disposed on the lower shelf 142 of the flap mount 170 to accept compressive force acting upon the bumper by the male engagement insert of the flap 168 when the flap 168 is receiving downwardly pulling forces from the submerged environment surrounding the flap 168. This ensures that the flap 168 does not exceed a certain downward position, preventing excessive movement or damage while maintaining optimal operational stability.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. An air lubrication system nozzle assembly, comprising:
a sea chest having an open cavity therein, wherein said sea chest includes a gas flow inlet, and an open lower boundary configured to receive a flow modulating nozzle flap;
a flow modulating nozzle flap, wherein said flap has a curved upper surface and is configured to modulate a direction and flow rate of a gaseous flow;
said sea chest having at least one longitudinal engagement area, wherein said at least one longitudinal engagement area is a rigidly fixed semi-circumferential bracket for mounting said flow modulating nozzle flap, wherein said rigidly fixed semi-circumferential bracket is affixed at a border of said open lower boundary;
said flow modulating nozzle flap is coupled to said at least one longitudinal engagement area; and
wherein said air lubrication system nozzle assembly is operable in a submerged environment.

2. The air lubrication system nozzle assembly, as recited in claim 1, wherein said flow modulating nozzle flap is coupled to said sea chest at said at least one longitudinal engagement area, wherein said at least one longitudinal engagement area is positioned at a forward area to direct flow of water under the flow modulating nozzle flap, and provide a surface for hydrodynamic forces to press against to close said flow modulating nozzle flap when no air is being dispensed from the opening of the nozzle assembly.

3. A method for providing air to an underside of a marine craft's submerged hull, comprising:
configuring portions of a ship's hull for air delivery to said ship's hull's lower surface by providing at least one flush-installed linear nozzle, wherein each of said at least one flush-installed linear nozzle is an air lubrication nozzle assembly;
providing said air lubrication nozzle assembly, wherein said air lubrication nozzle assembly is capable of being immersed continuously in a liquid, and said air lubrication system nozzle assembly includes:
a main body having an open cavity therein, wherein said main body includes a gas flow inlet, and an open lower boundary configured to receive a flow modulating nozzle flap, wherein said open lower boundary is flush with a transverse horizontal plane of a submerged hull of a ship surrounding said open lower boundary;
a flow modulating nozzle flap, wherein said flap has a curved upper surface and is configured to modulate a direction and flow rate of a gaseous flow;
said main body having at least one longitudinal engagement area, whereby said flow modulating nozzle is coupled to said at least one longitudinal engagement area;
wherein said air lubrication system nozzle assembly is operable in a submerged environment; and
wherein the main body of each nozzle in said at least one flush-installed linear nozzle is recessed up into the ship's hull.

4. The method for providing air to an underside of a marine craft's submerged hull, as recited in claim 3, wherein said air lubrication system nozzle assembly in said step of providing said air lubrication nozzle assembly capable of being immersed continuously in a liquid, further includes a semi-circumferential bracket for mounting said flow modulating nozzle flap.

5. The method for providing air to an underside of a marine craft's submerged hull as recited in claim 3, wherein the air lubrication nozzle assembly is capable of performing the steps of:
lowering said flow modulating nozzle flap by using a flow of gas received from said gas flow inlet to lower said flow modulating nozzle flap, wherein a flow of gas disburses uniformly in the open cavity of the main body, thereby pressing on said flow modulating nozzle flap to allow air to disburse to an underside of a marine craft's hull, when air is required under said marine craft's hull; and
raising said flow modulating nozzle flap by terminating a flow of gas received from said gas flow inlet, whereby a passive lifting system is incorporated into the flow modulating nozzle flap to allow for self-closure when said air is no longer required under said marine craft's hull.

6. An air lubrication nozzle system, comprising:
an open cavity configured to receive a gaseous flow from a gaseous supply, wherein said open cavity has an open bottom area flush with a plane of a bottom surface of a marine vessel in which said open cavity is installed;
a flap mount configured to affix to a front side wall of said open cavity, wherein said flap mount includes an aerodynamically concave-curved upper surface, rear flap engagement area, and bottom surface substantially flush with the plane of a bottom surface of a marine vessel;
a flap engaged with said flap mount, whereby once engaged, said flap creates an openable flap; and
said flap includes an aerodynamically concave-curved upper surface to guide the gaseous flow from a gaseous supply entering said open cavity and said gaseous supply routed from said upper surface of said flap mount.

7. The air lubrication nozzle system, as recited in claim 6, wherein a rear interior
surface wall of said open cavity is convex-curved to assist with guiding a gaseous supply from an inlet to an opening between said flap and said rear interior surface wall.

8. The air lubrication nozzle system, as recited in claim 6, wherein:
said flap is capable of creating a substantially sealed lower surface when a vessel is moving in a forward direction and no gaseous flow is traversing said open cavity.

9. The air lubrication nozzle system, as recited in claim 6, further comprising:
a stop limit means incorporated into a hinge mechanism between said flap and said flap mount, whereby said stop limit means allows the vessel to reverse without the flap descending below a threshold of approximately 10 mm below the hull of the ship.

10. The air lubrication nozzle system, as recited in claim 9, wherein said stop limit means comprises:
said hinge mechanism pivotally coupling said flap and said flap mount around a hinge point;
said hinge point allows said flap to rotate radially up and down between a predetermined distance contained between an upper shelf and a lower shelf on a flap mount portion of said hinge mechanism, thereby creating a female hinge cavity;
said flap having a male engagement insert having complemental geometry to said female hinge cavity whereby said male engagement insert of said flap will stop rotating upon reaching said upper or lower shelf of said flap mount; and
a bumper disposed on said lower shelf of said flap mount to accept compressive force acting upon said bumper by said male engagement insert of said flap when said flap is receiving downwardly pulling forces from the submerged environment surrounding said flap.

11. An air lubrication nozzle system, comprising:
an open cavity configured to receive a gaseous flow from a gaseous supply, wherein said open cavity has an open bottom area flush with an angular surface of a marine vessel's hull in which said open cavity is installed;
a flap mount configured to affix to a front side wall of said open cavity, wherein said flap mount includes an aerodynamically concave-curved upper surface, rear flap engagement area, and bottom surface substantially flush with the plane of a bottom surface of a marine vessel; and
a flap engaged with said flap mount, whereby once engaged, said flap creates an openable flap;
said flap is tapered having a wider geometry at a lower portion tapering into a narrow portion at an upper region, whereby said tapering allows a uniform air distribution by balancing the flow at a narrow opening where the air is more likely to flow, forcing the air to distribute lower open area where it can exit more easily; and
said flap mount includes a complemental taper to that of said flap to accommodate for a change in geometry of said flap.

12. The air lubrication nozzle system, as recited in claim 11, wherein said flap includes:
an aerodynamically concave-curved upper surface to guide the gaseous flow from both the gaseous supply and from a gaseous supply entering said open cavity and said gaseous supply routed from said upper surface of said flap mount.

13. The air lubrication nozzle system, as recited in claim 11, wherein a rear interior surface wall of said open cavity is convex-curved to assist with guiding a gaseous supply from an inlet to an opening between said flap and said rear interior surface wall.

14. The air lubrication nozzle system, as recited in claim 13, wherein said flap includes:
an aerodynamically concave-curved upper surface to guide the gaseous flow from both the gaseous supply and from a gaseous supply entering said open cavity and said gaseous supply routed from said upper surface of said flap mount.

15. The air lubrication nozzle system, as recited in claim 11, wherein:
said openable flap is capable of creating a substantially sealed surface when a vessel is moving in a forward direction and no gaseous flow is traversing said open cavity.

16. The air lubrication nozzle system, as recited in claim 11, further comprising:
a stop limit means incorporated into a hinge mechanism between said flap and said flap mount, whereby said stop limit means allows the vessel to reverse without the flap descending below an acceptable threshold.

17. The air lubrication nozzle system, as recited in claim 16, wherein said stop limit means comprises:
said hinge mechanism pivotally coupling said flap and said flap mount around a hinge point;
said hinge point allows said flap to rotate radially up and down between a predetermined distance contained between an upper shelf and a lower shelf on a flap mount portion of said hinge mechanism, thereby creating a female hinge cavity;
said flap having a male engagement insert having complemental geometry to said female hinge cavity whereby said male engagement insert of said flap will stop rotating upon reaching said upper or lower shelf of said flap mount; and
a bumper disposed on said lower shelf of said flap mount to accept compressive force acting upon said bumper by said male engagement insert of said flap when said flap is receiving downwardly pulling forces from the submerged environment surrounding said flap.
